(19) United States
(12) Patent Application Publication
(10) Pub. No.: US 2008/0145255 A1
(43) Pub. Date: Jun. 19, 2008

(54) Hydraulic pump for vehicle

(76) Inventor: Sok Hyun Jo, Suwon-city (KR)

Correspondence Address: MORGAN, LEWIS & BOCKIUS LLP (SF), One Market, Spear Street Tower, Suite 2800, San Francisco, CA, 94105, US

(21) Appl. No.: 11/784,018

(22) Filed: Apr. 5, 2007

(30) Foreign Application Priority Data
Dec. 14, 2006 (KR) 10-2006-0128190

(51) Int. Cl. F03C 2/08

(52) U.S. Cl. 418/61.3

(57) ABSTRACT

A hydraulic pump for a vehicle includes: a block; a pulley receiving an engine torque and rotating; a pump housing attached to the block; an outer rotor mounted in the pump housing; an inner rotor mounted inside the outer rotor, with gear teeth at an interior surface thereof; a pinion gear engaged to the interior surface of the inner rotor; a planet carrier connected to and rotating the pinion gear and having a carrier drive shaft with an end fixedly connected to the pulley; and a sun gear engaged to the pinion gear and having a sun gear drive shaft, housed in the carrier drive shaft, and axially slidable. A first end of the sun gear drive shaft is attached to the carrier drive shaft under a first operating condition, and a second end of the sun gear drive shaft is attached to the block under a second operating condition.

### CROSS-REFERENCE TO RELATED APPLICATION

This application claims priority to and the benefit of Korean Patent Application No. 10-2006-0128190 filed in the Korean Intellectual Property Office on Dec. 14, 2006, the entire contents of which are incorporated herein by reference.

### BACKGROUND OF THE INVENTION

(a) Field of the Invention

The present invention relates to a hydraulic pump for a vehicle. More particularly, the present invention relates to a hydraulic pump for a vehicle that controls an oil supply amount according to a rotational speed of an engine.

(b) Description of the Related Art

A conventional hydraulic pump for a vehicle includes an intake port and an exhaust port for receiving and exhausting oil, respectively, to and from a pump housing. An outer rotor and an inner rotor are further provided in the pump housing. The hydraulic pump also includes a pressure control valve, which puts the intake port and the exhaust port in fluid communication with one another when excess oil is input to the hydraulic pump.

The inner rotor is connected to a crank shaft of an engine and receives a rotational speed thereof. Therefore, as the rotational speed of the engine increases, oil supply and hydraulic pressure of the hydraulic pump increase.

Operational devices mounted at the engine must receive a hydraulic pressure that is larger than a set value, irrespective of the rotational speed of the engine, but the hydraulic pump only supplies sufficient oil to the engine when the rotational speed of the engine is high. Alternatively, if a pulley ratio of the hydraulic pump is increased such that oil is sufficiently supplied to the engine when the rotational speed of the engine is low, the oil is wasted when the rotational speed of the engine is high.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a hydraulic pump for a vehicle whose rotational speed is controlled.

A hydraulic pump for a vehicle according to an exemplary embodiment of the present invention includes: a block; a pulley receiving an engine torque and rotating; a pump housing fixed to the block; an outer rotor mounted in the pump housing; an inner rotor mounted on an inside of the outer rotor and having gear teeth at an interior surface thereof; a pinion gear engaged to the interior surface of the inner rotor; a planet carrier connected to and rotating the pinion gear and including a hollow carrier drive shaft that has a first end fixedly connected to the pulley; and a sun gear engaged to the pinion gear, and including a sun gear drive shaft that is housed in the carrier drive shaft and slides axially. Based on an operating condition of an engine, either a first end of the sun gear drive shaft is fixed to the carrier drive shaft, or the other end is fixed to the block.

The axial sliding of the sun gear drive shaft may be driven by an oil cylinder.

A bearing may be provided at one side of the block, and the sun gear drive shaft may be slidably housed in the bearing.

The oil cylinder may be mounted in the block.

The oil cylinder may operate when a rotational speed of an engine is larger than or equal to a predetermined value.

The first end of the sun gear drive shaft may be fixed to, and rotate together with, the carrier drive shaft when the oil cylinder operates.

The second end of the sun gear drive shaft may be inserted and rotate in the bearing when the oil cylinder operates.

The carrier drive shaft may include a fixing portion at the first end of the carrier drive shaft, and an elastic member may be interposed between the first end of the carrier drive shaft and the first end of the sun gear drive shaft.

The first end of the sun gear drive shaft may be splined to the fixing portion of the carrier drive shaft when the oil cylinder operates.

The sun gear drive shaft may be disengaged from the fixing portion by an elastic force of the elastic member when the oil cylinder does not operate.

The second end of the sun gear drive shaft may penetrate the bearing and be fixed to the block when the oil cylinder does not operate.

The second end of the sun gear drive shaft may be splined to the block.

### BRIEF DESCRIPTION OF THE DRAWINGS

FIG. 1 is a perspective view of a hydraulic pump for a vehicle according to an exemplary embodiment of the present invention.

FIG. 2 is a perspective view of a pinion gear and a sun gear mounted at an inside of an inner rotor according to an exemplary embodiment of the present invention.

FIG. 3 is a perspective view of a bearing between a block and a sun gear drive shaft according to an exemplary embodiment of the present invention.

FIG. 4 is a perspective view of a sun gear drive shaft and an oil cylinder connected with each other according to an exemplary embodiment of the present invention.

FIG. 5 is a schematic cross-sectional view of a sun gear drive shaft fixed to a carrier drive shaft, when an oil cylinder operates, according to an exemplary embodiment of the present invention.

FIG. 6 is a schematic cross-sectional view oft a sun gear drive shaft fixed to a block, when an oil cylinder does not operate, according to an exemplary embodiment of the present invention.

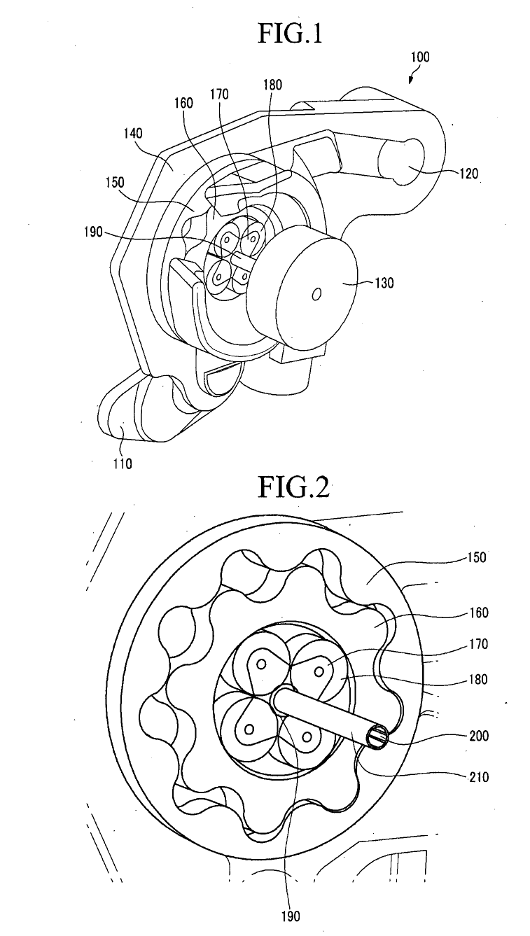

### DETAILED DESCRIPTION OF THE PREFERRED EMBODIMENTS

An exemplary embodiment of the present invention will hereinafter be described in detail with reference to the accompanying drawings.

According to an exemplary embodiment of the present invention, a hydraulic pump 100 for a vehicle includes a block 220, a pulley 130, a pump housing 140, an outer rotor 150, an inner rotor 160, a pinion gear 180, a planet carrier 170, and a sun gear 190.

The pulley 130 is connected to a crank shaft of an engine. Thus, the pulley 130 receives an engine torque and rotates.

The pump housing 140 is fixed to the block 220. The pump housing 140 includes an intake port 110 for receiving oil thereto and an exhaust port 120 for exhausting the oil therefrom.

The outer rotor 150 is mounted in the pump housing 140, and the inner rotor 160 is mounted at an inside of the outer rotor 150. Gear teeth are provided at an interior surface of the inner rotor 160 such that the inner rotor 160 operates as a ring gear of a planetary gear set.

The pinion gear 180 is engaged to the interior surface of the inner rotor 160.

The planet carrier 170 is connected to and rotates the pinion gear 180. The planet carrier 170 includes a hollow carrier drive shaft 200, and one end of the carrier drive shaft 200 is fixed to the pulley 130. Therefore, the planet carrier 170 rotates with the pulley 130. A fixing portion 290 is provided at the one end the carrier drive shaft 200.

The sun gear 190 is engaged to the pinion gear 180. A sun gear drive shaft 210 penetrates a middle portion of the sun gear 190. The sun gear drive shaft 210 is splined to the sun gear 190. Therefore, the sun gear drive shaft 210 transmits torque to the sun gear 190. The sun gear drive shaft 210 slides in an axial direction thereof and is fixed to the carrier drive shaft 200 or the block 220 according to an operating condition.

In addition, an oil cylinder 240 is mounted in the block 220, and a bearing 230 is inserted at one side of the block 220.

The oil cylinder 240 is connected to an oil supply line 250 and receives oil. An oil exhaust line 260 branches off of the oil supply line 250. An oil supply valve 270 and an oil exhaust valve 280 are respectively mounted to the oil supply line 250 and the oil exhaust line 260, and control oil supply to the oil cylinder 240.

The oil cylinder 240 receives the oil through the oil supply line 250, and operates only when a rotational speed of the engine is larger than a predetermined value, such as, without limitation, 2000 rpm. In operation, the oil cylinder 240 pushes the sun gear drive shaft 210 and splines the sun gear drive shaft 210 to the fixing portion 290 of the carrier drive shaft 200. Accordingly, the sun gear 190 rotates with the planet carrier 170.

An elastic member 300, such as a coil spring, is interposed between the first end of the sun gear drive shaft 210 and the first end of the carrier drive shaft 200. When the oil cylinder 240 does not operate, the elastic member 300 applies an elastic force to the sun gear drive shaft 210 and disengages the sun gear drive shaft 210 from the fixing portion 290.

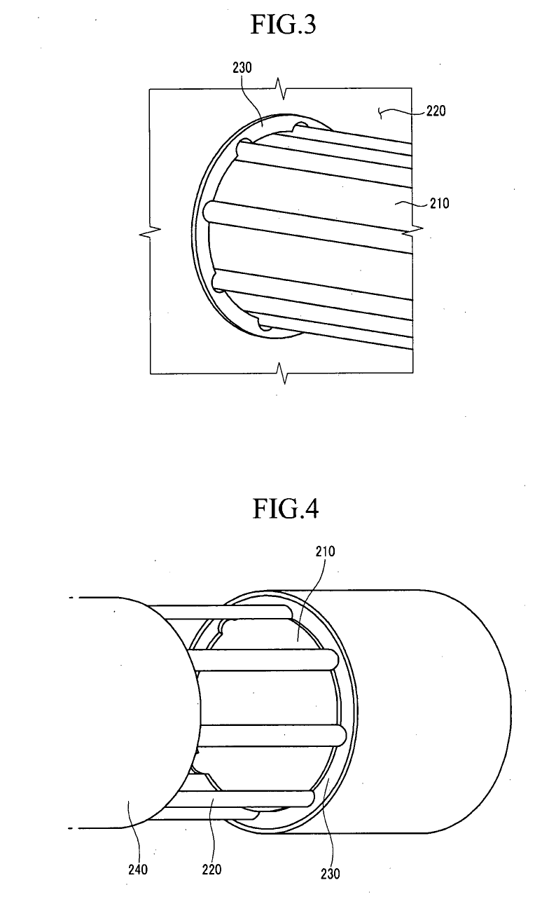

In addition, the second end of the sun gear drive shaft 210 penetrates and slides in the bearing 230. The sun gear drive shaft 210, as shown in FIG. 3, is splined to the bearing 230. When the oil cylinder 240 operates, the second end of the sun gear drive shaft 210 is inserted and rotates in the bearing 230. When the oil cylinder 240 does not operate, the second end of the sun gear drive shaft 210 penetrates the bearing 230 and is splined to the block 220 by the elastic force of the elastic member 300. Accordingly, the sun gear 190 stops.

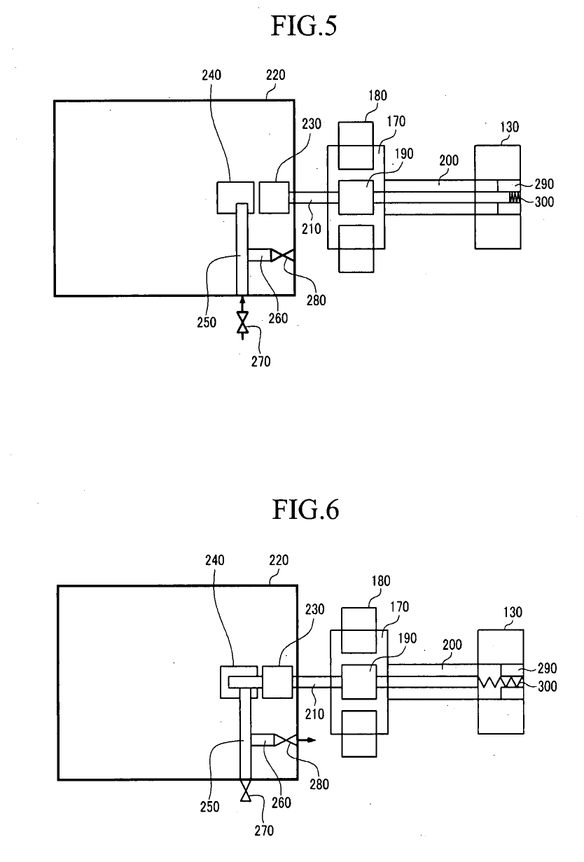

Referring to FIGS. 5 and 6, operation of a hydraulic pump according to an exemplary embodiment of the present invention will now be described in detail.

As shown in FIG. 5, when the rotational speed of the engine is larger than or equal to the predetermined value, the oil cylinder 240 operates and pushes the sun gear drive shaft 210 to the right in the drawing. Accordingly, the first end of the sun gear drive shaft 210 is splined to the fixing portion 290 of the carrier drive shaft 200. In addition, the second end of the sun gear drive shaft 210 is completely inserted in the bearing 230, and the sun gear drive shaft 210 rotates in the bearing 230. Therefore, the sun gear 190 and the planet carrier 200 rotate with the same rotational speed as the pulley 130, and accordingly, the inner rotor 160 also rotates with the same rotational speed as the pulley 130. Therefore, oil supply of the hydraulic pump 100 is kept constant.

As shown in FIG. 6, when the rotational speed of the engine is smaller than the predetermined value, the oil cylinder 240 does not operate, and the elastic member 300 moves the sun gear drive shaft 210 to the left in the drawing. In this case, the first end of the sun gear drive shaft 210 is disengaged from the fixing portion 290, and the second end of the sun gear drive shaft 210 penetrates the bearing 230 and is splined to the block 220. The planet carrier 200 rotates with the same rotational speed as the pulley 130, and the sun gear 190 stops. Therefore, the inner rotor 160 rotates with a larger rotational speed than the rotational speed of the pulley 130. Therefore, the oil supply of the hydraulic pump 100 increases.

That is, the inner rotor 160 rotates with a larger rotational speed than the rotational speed of the engine when the rotational speed of the engine is small, and rotates with the same rotational speed as the engine when the rotational speed of the engine is large.

According to the present invention, a rotational speed of a hydraulic pump increases when a rotational speed of an engine is small, and the rotational speed of the hydraulic pump decreases when the rotational speed of the engine is large. Therefore, sufficient oil is supplied to the engine even when the rotational speed of the engine is small, and oil waste is reduced when the rotational speed of the engine is large. Therefore, energy waste may be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A hydraulic pump for a vehicle, comprising:
a block;
a pulley receiving an engine torque and rotating;
a pump housing attached to the block;
an outer rotor mounted in the pump housing;
an inner rotor mounted inside the outer rotor, and comprising gear teeth at an interior surface thereof;
a pinion gear engaged to the interior surface of the inner rotor;
a planet carrier connected to and rotating the pinion gear and comprising a carrier drive shaft, the carrier drive shaft comprising a first end fixedly connected to the pulley; and
a sun gear engaged to the pinion gear and comprising a sun gear drive shaft that is at least partially housed in the carrier drive shaft and is axially slidable;
wherein a first end of the sun gear drive shaft is attached to the carrier drive shaft under a first operating condition of an engine, and a second end of the sun gear drive shaft is attached to the block under a second operating condition of the engine.

2. The hydraulic pump of claim 1, further comprising an oil cylinder for axially sliding the sun gear drive shaft.

3. The hydraulic pump of claim 2, wherein the oil cylinder is mounted in the block.

4. The hydraulic pump of claim 1, further comprising a bearing at one side of the block, wherein the sun gear drive shaft penetrates and slides in the bearing.

5. The hydraulic pump of claim 4, further comprising an oil cylinder for axially sliding the sun gear drive shaft, wherein the oil cylinder operates when a rotational speed of an engine is larger than or equal to a predetermined value.

6. The hydraulic pump of claim 5, wherein the first end of the sun gear drive shaft is fixed to and rotates together with the carrier drive shaft when the oil cylinder operates.

7. The hydraulic pump of claim 6, wherein the second end of the sun gear drive shaft is inserted and rotates in the bearing when the oil cylinder operates.

8. The hydraulic pump of claim 6, wherein the carrier drive shaft comprises a fixing portion at the first end of the carrier drive shaft, and an elastic member interposed between the first end of the carrier drive shaft and the first end of the sun gear drive shaft.

9. The hydraulic pump of claim 8, wherein the first end of the sun gear drive shaft is splined to the fixing portion of the carrier drive shaft when the oil cylinder operates.

10. The hydraulic pump of claim 8, wherein the sun gear drive shaft is disengaged from the fixing portion by an elastic force of the elastic member when the oil cylinder does not operate.

11. The hydraulic pump of claim 10, wherein the second end of the sun gear drive shaft penetrates the bearing and is fixed to the block when the oil cylinder does not operate.

12. The hydraulic pump of claim 11, wherein the second end of the sun gear drive shaft is splined to the block.
